(19) United States
(12) Patent Application Publication
(10) Pub. No.: US 2014/0113508 A1
(43) Pub. Date: Apr. 24, 2014

(54) LOCKING DEVICE AND CONNECTOR ARRANGEMENT HAVING SUCH A LOCKING DEVICE

(71) Applicants: Klaus-Michael Bath, Blomberg (DE); Sebastian Schaefer, Blomberg (DE)

(72) Inventors: Klaus-Michael Bath, Blomberg (DE); Sebastian Schaefer, Blomberg (DE)

(73) Assignee: PHOENIX CONTACT GMBH & CO. KG, Blomberg (DE)

(21) Appl. No.: 14/123,105

(22) PCT Filed: Jun. 1, 2012
(86) PCT No.: PCT/EP2012/002349

§ 371 Date: Nov. 28, 2013

(30) Foreign Application Priority Data
Jun. 1, 2011 (DE) 10 2011 103 785.7

(51) Int. Cl. H01R 13/627

(52) U.S. Cl. CPC H01R 13/627
USPC 439/816

(57) ABSTRACT

A locking device for fastening a connection element to a housing of a connector arrangement with a substantially u-shaped spring element. The spring element has a first limb and a second limb that is arranged substantially parallel to the first limb in a state of rest of the spring element, wherein the first limb is longer than the second limb.

### CROSS-REFERENCE TO RELATED APPLICATIONS

This application is a U.S. National Phase application under 35 U.S.C. §371 of International Application No. PCT/EP2012/002349, filed on Jun. 1, 2012, and claims benefit to German Patent Application No. DE 10 2011 103 785.7, filed on Jun. 1, 2011. The International Application was published in German on Dec. 6, 2012, as WO 2012/163547 A1 under PCT Article 21(2).

### FIELD

The invention relates to a locking device for fastening a connection element to a housing of a connector arrangement. The invention further relates to a connector arrangement of this type.

### BACKGROUND

Connector arrangements which are used in particular for solar modules have high safety requirements on the fastening of a connection element, in particular a connector. In this context, an important criterion is that it should not be possible to release the connection elements without using a tool.

### SUMMARY

An aspect of the invention provides a locking device configured to fasten a connection element to a housing of a connector arrangement. The locking device includes a substantially U-shaped spring element, the spring element including: a first limb; and a second limb. The second limb is disposed substantially parallel to the first limb in a state of rest of the spring element, and the first limb is longer than the second limb.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic perspective view of a connector arrangement according to the invention;

FIG. 2 is a schematic plan view, onto the end face of the connector arrangement, of the connector arrangement according to the invention shown in FIG. 1;

FIG. 3 is a schematic perspective drawing of a spring element of a locking device according to the invention; and

FIG. 4 is a schematic plan view, onto a longitudinal side face of the spring element, of a spring element of a locking device according to the invention.

### DETAILED DESCRIPTION

An aspect of the invention provides a solution with which the fulfilment of the high safety requirements can be further improved. An additional aspect of the invention simplifies the mounting of a locking element on a housing and largely to prevent mounting errors.

In a locking device of the type described in greater detail above, an aspect of the invention provides the locking device comprises a substantially U-shaped spring element, which comprises a first limb and a second limb that is arranged substantially parallel to the first limb in a state of rest of the spring element, the first limb being longer than the second limb.

In a connector arrangement of the type described in greater detail above, an aspect of the invention provides the connector arrangement comprises a housing, having a through-hole for passing a locking element of a connection element through, it being possible to arrange a locking device of the invention in the region of the through-hole, a delimiting element being arranged adjacent to the through-hole on the housing and serving as a positioning aid for the spring element of the locking device.

The spring element serves to fasten the locking element of a connection element, which is passed through a through-hole of the housing, securely to the housing, in such a way that the connection element cannot be released from the housing without using a tool. The connection element may be a connector, in particular a multi-pole solar connector, which in addition to the connection contacts thereof preferably comprises two locking elements, which may for example be in the form of pins which protrude from the end face or the connection face of the connection element. The locking device is formed as a leg spring in the form of a substantially U-shaped spring element, which comprises two limbs that extend substantially mutually parallel in a state of rest of the spring element. The state of rest of the spring element is the state in which the spring element is not actuated, for example by a tool or when fastening the spring element to the housing. Preferably, the state of rest is the state in which locking of the locking element is provided by means of the spring element. In this state, the locking element is held gripped between the two limbs of the spring element. So as to facilitate mounting of the spring element on the housing and to prevent errors during mounting, the two limbs of the spring element are of different lengths. In addition, a delimiting element is arranged adjacent to the through-hole on the housing itself and serves as a type of positioning aid for the spring element. The delimiting element determines the space available for positioning the spring element on the housing for one of the two limbs of the spring element. In this context, the delimiting element is arranged in such a way that the spring element can only be arranged on the housing in such a way that only the shorter limb of the spring element, in this case the second limb, can be arranged directly alongside or adjacent to the delimiting element. If the longer limb, in this case the first limb, were inserted into this region, this longer limb would overlap the delimiting element. It is not possible to position the longer limb of the spring element in this region. The spring element can thus only be arranged on the housing from one possible direction. The delimiting element may for example be in the form of a web protruding from the housing.

In accordance with an embodiment according to the invention of the locking element, the spring element may comprise a first insertion aid for a locking element, which is to be fastened, of the connection element. The insertion aid serves to facilitate the insertion of the locking element into the spring element, in particular into the region between the two limbs of the spring element, so as in particular to prevent undesired jamming and misalignment of the locking element during insertion, in such a way that rapid and reliable fastening of the locking element on the housing can be ensured.

It may further preferably be provided that the spring element comprises a second insertion aid for inserting a tool, with which the limb positioned on the locking element can be released from the locking element in such a way that the locking element can be released from the spring element so as to be able to remove the connection element from the housing.

In accordance with a further preferred embodiment of the locking device, the first insertion aid is formed opposite the second insertion aid on the spring element. This makes it possible to insert a tool easily into the spring element when the tool is inserted counter to the insertion direction of the locking element into an internal space of the spring element, formed by the two limbs of the spring element, to release the spring element.

Further, it is preferably provided that the first insertion aid and/or the second insertion aid are in the form of an edge region which is formed curved on the first limb and on the second limb respectively. In this context, the curved edge region is formed on a longitudinal side face of the limb in each case. In this context, this curved edge region, which is preferably in the form of a lip, is preferably curved away from an internal space of the spring element formed by the first limb and the second limb, in such a way that the curved edge region protrudes outwards from the spring element. The curved edge region makes it possible to guide the locking element and/or the tool directly into the internal space of the spring element.

So as to configure the fastening of the locking element to the spring element as reliably as possible, it is further preferably provided that the spring element comprises a latching region for latching from behind onto a locking element, which is to be fastened, of the connection element. The latching region additionally serves as a type of strain relief for the locking element fastened to the latching region.

In this context, the latching region is preferably in the form of a sharp edge region formed on the first limb and on the second limb. In this context, “sharp edge region” means that the thickness of the edge region is as small as possible, in such a way that an inserted locking element can engage the spring element as easily as possible from behind in this edge region and can latch firmly onto it. For example, this edge region may be provided with a bevel or a chamfer for reducing the thickness of the limb in this region. However, it is also possible for the sharp edge region to be of the same thickness as the middle of the limb on which the edge region is formed.

So as to facilitate opening the spring element by means of a tool, in accordance with a development according to the invention of the connector arrangement, it is provided that the housing comprises a tool insertion hole formed adjacent to the through-hole. This means in particular that the insertion direction of the tool can be made the same as the insertion direction of the locking element. In addition, the tool insertion hole makes it possible to guide the tool towards the spring element in a targeted manner, so as to make rapid, targeted opening of the lock possible by means of a tool, for example a screwdriver.

So as to prevent incorrect insertion of the locking element into the tool insertion hole or of the tool into the through-hole, the tool insertion hole preferably comprises a peripheral surface which is of a different shape from the through-hole.

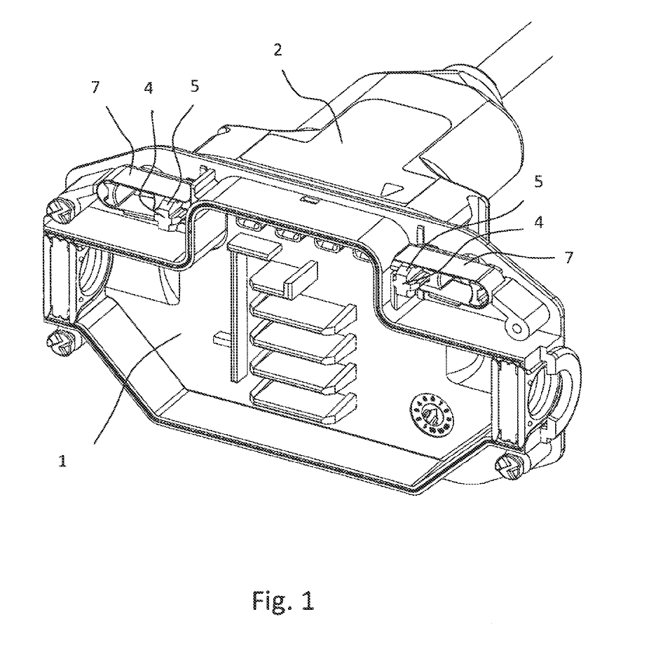

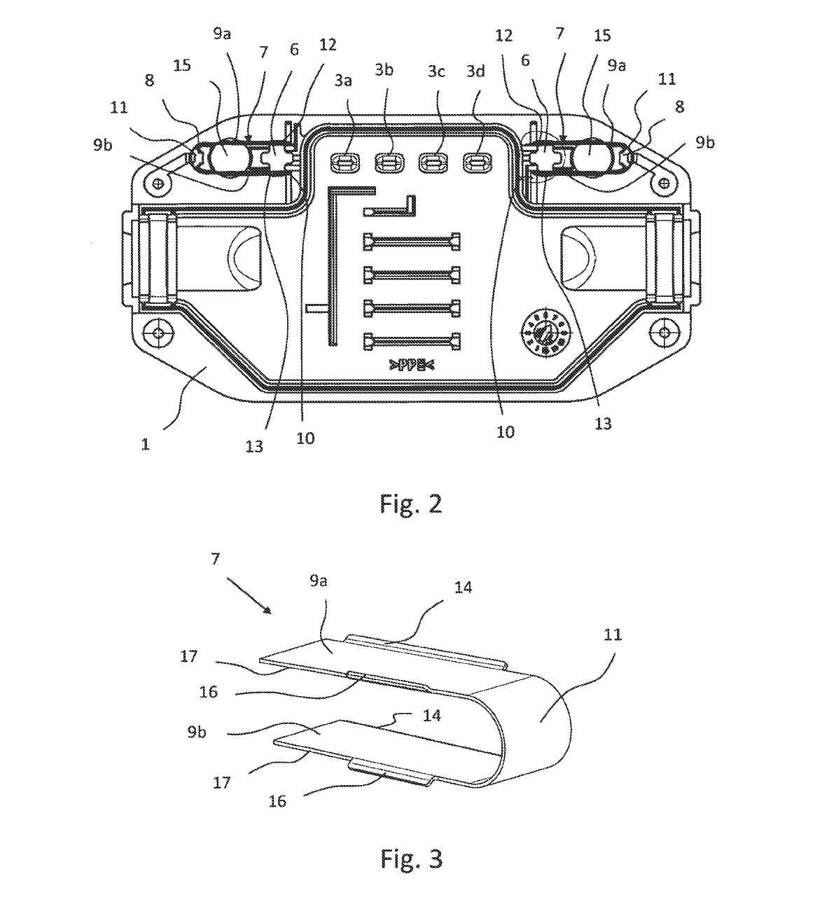

FIG. 1 and FIG. 2 schematically show a connector arrangement according to the invention comprising a housing 1 and a connection element 2 in the form of a connector, in particular a multi-pole solar connector, arranged on the housing 1. In this case, the housing 1 is shown when open. In this context, FIG. 1 shows the connector arrangement together with a connection element 2 arranged thereon. FIG. 2 shows the connector arrangement without a connection element arranged thereon.

The connection element 2 comprises two locking elements 4, which are each arranged laterally alongside the connection contacts 3a-3d thereof, shown in FIG. 2, and by means of which the connection element 2 can be fastened to the housing 1. The locking elements 4 are in the form of pins, which have a cross-shaped cross-section in the embodiment shown here. At the free end region thereof, the locking elements 4 comprise one or more, preferably two latching tabs 5, which are formed opposite and which can latch into an undercut from behind.

To fasten the connection element 2 to the housing 1, the locking elements 4 are each passed through a through-hole 6, which is formed on the housing 1 and is shown in FIG. 2. In this context, the shape of the peripheral surface of the through-hole 6 is adapted to the shape of the cross-section of the locking element 4, and so in the embodiment shown here the peripheral surface of the through-hole 6 is cross-shaped.

To fasten the locking elements 4 to the housing 1, two spring elements 7 of a locking device are provided and can be fastened to the housing 1 by way of a holding element 8 formed on the housing 1. The spring elements 7 are each U-shaped in form and comprise a first limb 9a and a second limb 9b, which is arranged substantially parallel to the first limb 9a in a state of rest of the spring element 7 as shown in FIGS. 1 and 2. The two limbs 9, 9b are of different lengths, the first limb 9a being longer than the second limb 9b in the embodiment shown here.

A delimiting element 10 in the form of a web is formed adjacent to the through-hole 6 on the housing 1, and extends over a portion of the length of the through-hole 6, in such a way that in the embodiment shown here the delimiting element 10 extends past the lower edge 13 of the through-hole 6, but is not formed in the region of the upper edge 12 of the through-hole 6. The delimiting element 10 delimits the possible positioning region of one of the two limbs 9a, 9b of the spring element 7 starting from the holding element 8 on which the U-shaped curve 11 of the spring element 7 is positioned. In this context, the delimitation is specifically of a size such that only the shorter limb 9b of the spring element 7 fits into and can be inserted into this positioning region. This fixes the possible fastening direction of the spring element 7 to the housing 1, and incorrect mounting of the spring element 7 can thus be prevented.

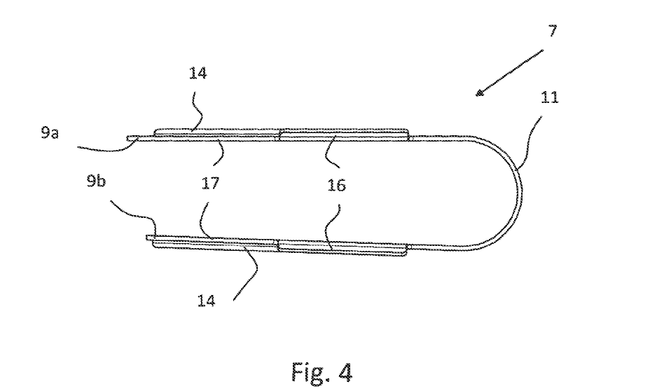

FIGS. 3 and 4 provide a more detailed illustration of the spring element 7. To simplify the insertion of a locking element 4 into an internal space, which is formed by the two limbs 9a, 9b of the spring element 7 and in which the locking element 4 is held gripped, the spring element 7 comprises a first insertion aid 14. The first insertion aid 14 is in the shape of a curved edge region both on the first limb 9a and on the second limb 9b. The two curved edge regions of the first insertion aid 14 are formed on the two limbs 9a, 9b in such a way that they are opposite one another. In the embodiment shown here, the first insertion aid 14 is formed in such a way that it extends past the region of the through-hole 6 and also past a tool insertion hole 15 arranged adjacent to the through-hole 6 when the spring element 7 is positioned on the housing 1. In this way, the first insertion aid 14 can also serve to guide a tool which is inserted into the internal space of the spring element 7 via the tool insertion hole 15. If the spring element 7 is positioned on the housing 1, the first insertion aid 14 is positioned directly on the housing 1.

In addition to the first insertion aid 14, the spring element 7 comprises a second insertion aid 16, which is arranged opposite the first insertion aid 16 on the two limbs 9a, 9b. The second insertion aid 16, just like the first insertion aid 14, is in the form of a curved edge region both on the first limb 9a and on the second limb 9b. The two curved edge regions of the second insertion aid 16 are formed on the two limbs 9a, 9b in such a way that they are opposite one another. Unlike the first insertion aid 14, however, the second insertion aid 16 only extends past the region of the tool insertion hole 15 and not past the region of the through-hole 6 when the spring element 7 is positioned on the housing 1. When the spring element 7 is positioned on the housing 1, the second insertion aid 16 is formed on the edge region of the spring element 7 or of the limbs 9a, 9b which faces away from the housing 1. The second insertion aid 16 serves to guide a tool into the internal space of the spring element 7 when the tool is guided into the internal space of the spring element 7 counter to the insertion direction of the locking elements 4 to open the spring element 7, rather than via the tool insertion hole 15.

The curved edge regions of the first insertion aid 14 and the second insertion aid are each in the form of a lip which is curved away from the internal space of the spring element 15, in such a way that the curved edge regions protrude outwards from the spring element 7.

A latching region 17, onto which the latching tabs 5 of the locking element 4 can engage from behind or latch, is formed on the first limb 9a and on the second limb 9b of the spring element 7, adjacent to the second insertion aid 16. The latching region 17 is in the form of a sharp edge region on the first limb 9a and on the second limb 9b. In the region of the latching region 17, the edge region of the limbs 9a, 9b is less thick than the edge region of the limbs 9a, 9b in the region of the first and second insertion aid 14, 16. Latching is also not possible in the region of the first and second insertion aid 14, 16, since the curved edge regions which are formed here mean that the thickness of the edge regions is too great, and so the latching tabs 5 of the locking element 4 cannot latch or engage from behind here.

FIG. 4 is an illustration of the spring element 7 in which the different lengths of the limbs 9a, 9b can clearly be seen.

So as to release the locking or latching of the locking element 4 to the spring element 7, a tool, for example a screwdriver, by means of which the limbs 9a, 9b of the spring element 7 are pushed apart, is inserted into the internal space of the spring element 7, in such a way that the locking element 4 can be released from the latching region 17 and the locking element 4 can be removed from the housing 1 via the through-hole 6. The tool is preferably inserted via the tool insertion hole 15 on the housing 1. So as to prevent incorrect insertion of the locking element 4 into the tool insertion hole 15 or of the tool into the through-hole 6, the tool insertion hole 15 preferably has a peripheral surface of a different shape from the through-hole 6, in that the peripheral surface of the through-hole 6 is cross-shaped and the peripheral surface of the tool insertion hole 15 is circular.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and

### LIST OF REFERENCE NUMERALS

Housing 1
Connection element 2
Connection contacts 3a-3d
Locking element 4
Latching tab 5
Through-hole 6
Spring element 7
Holding element 8
First limb 9a
Second limb 9b
Delimiting element 10
U-shaped curve 11
Upper edge 12
Lower edge 13
First insertion aid 14
Tool insertion hole 15
Second insertion aid 16
Latching region 17

1: A locking device configured to fasten a connection element to a housing of a connector arrangement, the locking device comprising a substantially U-shaped spring element, the spring element including:
a first limb; and
a second limb,
wherein the second limb is disposed substantially parallel to the first limb in a state of rest of the spring element, and
wherein the first limb is longer than the second limb.

2: The locking device of claim 1, wherein the spring element further includes a first insertion aid for a locking element, which is to be fastened, of the connection element.

3: The locking device of claim 1, wherein the spring element further includes a second insertion aid configured for inserting a tool.

4: The locking device of claim 3, wherein the first insertion aid is formed opposite the second insertion aid on the spring element.

5: The locking device of claim 3, wherein at least one of the first insertion aid and the second insertion aid are in the form of an edge region,
wherein the edge region is formed curved on the first limb and on the second limb.

6: The locking device of claim 1, wherein the spring element further includes a latching region configured to latch from behind onto a locking element, which is to be fastened, of the connection element.

7: The locking device of claim 6, wherein the latching region is in the form of a sharp edge region formed to fit at least one of the first limb and on the second limb.

8: A connector arrangement, comprising
a housing, including
a through-hole suitable for passing a locking element of a connection element therethrough,
wherein the housing is configured to accommodate the locking device of claim 1 in the region of the through-hole,
wherein a delimiting element is disposed adjacent to the through-hole on the housing,
wherein the delimiting element is configured to serve as a positioning aid for the spring element of the locking device.

9: The connector arrangement of claim 8, wherein the housing further includes a tool insertion hole formed adjacent to the through-hole.

10: The connector arrangement of claim 9, wherein the tool insert on hole includes a peripheral surface, and
wherein the peripheral surface has a different shape from the through-hole.

11: The locking device of claim 2, wherein the spring element further includes a second insertion aid configured for inserting a tool.

12: The locking device of claim 11, wherein the first insertion aid is formed opposite the second insertion aid on the spring element.

13: The locking device of claim 11, wherein at least one of the first insertion aid and the second insertion aid are in the form of an edge region,
wherein the edge region is formed curved on the first limb and on the second limb.

14: The locking device of claim 5, wherein the first insertion aid is in the form of the edge region.

15: The locking device of claim 5, wherein the second insertion aid is in the form of the edge region.

16: The locking device of claim 5, wherein the first insertion aid and the second insertion aid are in the form of the edge region.
